(19) United States
(12) Patent Application Publication
(10) Pub. No.: US 2020/0057149 A1
(43) Pub. Date: Feb. 20, 2020

(54) OPTICAL SENSOR AND ELECTRONIC DEVICE

(71) Applicant: SONY CORPORATION, Tokyo (JP)

(72) Inventors: Katsuhisa KUGIMIYA, Kanagawa (JP); Hiroshi TAKAHASHI, Kanagawa (JP); Kenji AZAMI, Kanagawa (JP)

(73) Assignee: SONY CORPORATION, Tokyo (JP)

(21) Appl. No.: 16/609,378

(22) PCT Filed: Apr. 27, 2018
(86) PCT No.: PCT/JP2018/017150

§ 371 Date: Oct. 29, 2019

(30) Foreign Application Priority Data
May 11, 2017 (JP) 2017-094357

(51) Int. Cl. G01S 7/486; G01S 7/481; G01S 17/10

(52) U.S. Cl. CPC G01S 7/4861; G01S 17/10; G01S 7/4816

(57) ABSTRACT

The present technology relates to an optical sensor that can suppress a decrease in distance measurement accuracy without increasing power consumption, and an electronic device. The optical sensor includes: a TOF pixel that receives reflected light which is returned when irradiation light emitted from a light emitting unit is reflected on a subject; and a plurality of polarization pixels that respectively receives light beams of a plurality of polarization planes, the light beams being a part of light from the subject. The present technology can be applied to, for example, the cases where distance measurement is performed.

### TECHNICAL FIELD

The present technology relates to an optical sensor and an electronic device, and more particularly to an optical sensor that can suppress a decrease in distance measurement accuracy without increasing power consumption, for example, and an electronic device.

### BACKGROUND ART

As a distance measurement method for measuring a distance to a subject (target object), there is, for example, a time of flight (TOF) method (see Patent Document 1, for example).

In the TOF method, in principle, irradiation light, which is light emitted to a subject, is emitted, and reflected light that is returned from the subject when the irradiation light is reflected on the subject is received, by which the flight time of light from when the irradiation light is emitted until the reflected light is received, that is, the flight time Δt until the irradiation light is reflected on the subject and returned, is obtained. Then, the distance L to the subject is obtained according to the equation L=c×Δt/2 using the flight time Δt and the speed of light c [m/s].

In the TOF method, for example, infrared light having, for example, a pulse waveform or a sine waveform having a period of several tens of nm per second is used as irradiation light. Furthermore, when the TOF method is practically applied, a phase difference between the irradiation light and the reflected light is obtained as (a value proportional to) the flight time Δt on the basis of an amount of reflected light received during an on-period of the irradiation light and an amount of reflected light received during an off-period of the irradiation light, for example.

In the TOF method, since the distance to the subject is obtained on the basis of the phase difference (flight time Δt) between the irradiation light and the reflected light as described above, accuracy in measuring a long distance is higher than that in, for example, a stereo vision method with which a distance is measured using the principle of triangulation or in a structured light method. Furthermore, in the TOF method, a light source that emits the irradiation light and a light receiving unit that receives the reflected light are disposed close to each other, so that a device can be miniaturized.

### CITATION LIST

### Patent Document

Patent Document 1: Japanese Patent Application Laid-Open No. 2016-90436

### SUMMARY OF THE INVENTION

### Problems to be Solved by the Invention

Meanwhile, in the TOF method, since the accuracy in measuring a distance is determined by the signal to noise ratio (S/N) of a light reception signal obtained by receiving the reflected light, the light reception signals are integrated for the accuracy of distance measurement.

Furthermore, in the TOF method, although the accuracy of distance measurement is less dependent on the distance than a stereo vision method or a structured light method, the accuracy of distance measurement is still deteriorated, as the distance is longer.

As a method of maintaining the accuracy of distance measurement when a long distance is measured, there are a method of increasing the intensity of irradiation light and a method of extending an integration period for integrating light reception signals.

However, the method of increasing the intensity of irradiation light and the method of extending an integration period for integrating light reception signals cause an increase in power consumption.

Furthermore, in the TOF method, the distance may be erroneously detected for, for example, a subject on which specular refection occurs, such as a mirror or water surface.

The present technology has been made in view of such circumstances, and is intended to be able to suppress a decrease in distance measurement accuracy without increasing power consumption.

### SOLUTIONS TO PROBLEMS

An optical sensor according to the present technology is provided with a TOF pixel that receives reflected light which is returned when irradiation light emitted from a light emitting unit is reflected on a subject, and a plurality of polarization pixels that respectively receives light beams of a plurality of polarization planes, the light beams being a part of light from the subject.

An electronic device according to the present technology includes an optical system that condenses light and an optical sensor that receives light, the optical sensor including a TOF pixel that receives reflected light which is returned when irradiation light emitted from a tight emitting unit is reflected on a subject, and a plurality of polarization pixels that respectively receives light beams of a plurality of polarization planes, the light beams being a part of light from the subject.

In the optical sensor and the electronic device according to the present technology, the TOF pixel receives reflected light which is returned when irradiation light emitted from a light emitting unit is reflected on a subject, and the plurality of polarization pixels respectively receives light beams of a plurality of polarization planes, the light beams being a part of light from the subject.

Note that the optical sensor may be an independent device or an internal block that constitutes a single device.

### EFFECTS OF THE INVENTION

According to the present technology, it is possible to suppress a decrease in distance measurement accuracy without increasing power consumption.

Note that the effects described herein are not necessarily limitative, and any of the effects described in the present disclosure may be exhibited.

### BRIEF DESCRIPTION OF DRAWINGS

FIG. 1 is a block diagram showing a configuration example of an embodiment of a distance measuring apparatus to which the present technology is applied.

FIG. 2 is a block diagram showing an example of an electrical configuration of an optical sensor 13.

FIG. 3 is a circuit diagram showing a basic configuration example of a pixel 31.

FIG. 4 is a plan view showing a first configuration example of a pixel array 21.

FIG. 5 is a sectional view showing a configuration example of a polarization pixel 31P and a TOF pixel 31T in the first configuration example of the pixel array 21.

FIG. 6 is a diagram for describing the principle of distance calculation with a TOF method.

FIG. 7 is a plan view showing a configuration example of a polarization sensor 61.

FIG. 8 is a circuit diagram showing an electric configuration example of the polarization sensor 61.

FIG. 9 is a plan view showing a configuration example of a TOF sensor 62.

FIG. 10 is a circuit diagram showing an electric configuration example of the TOF sensor 62.

FIG. 11 is a plan view showing a second configuration example of the pixel array 21.

FIG. 12 is a sectional view showing a configuration example of a polarization pixel 31P and a TOF pixel 31T in the second configuration example of the pixel array 21.

FIG. 13 is a plan view showing a third configuration example of the pixel array 21.

FIG. 14 is a sectional view showing a configuration example of a polarization pixel 31P and a TOF pixel 31T in the third configuration example of the pixel array 21.

FIG. 15 is a plan view showing a fourth configuration example of the pixel array 21.

FIG. 16 is a sectional view showing a configuration example of a polarization pixel 31P and a TOF pixel 31T in the fourth configuration example of the pixel array 21.

FIG. 17 is a plan view showing a fifth configuration example of the pixel array 21.

FIG. 18 is a sectional view showing a configuration example of a polarization pixel 31P and a TOF pixel 31T in the fifth configuration example of the pixel array 21.

FIG. 19 is a block diagram showing an example of a schematic configuration of a vehicle control system.

FIG. 20 is an explanatory view showing exemplary positions where a vehicle external information detection unit and an imaging unit are mounted.

### MODE FOR CARRYING OUT THE INVENTION

### One Embodiment, of Distance Measuring Apparatus to Which Present Technology is Applied

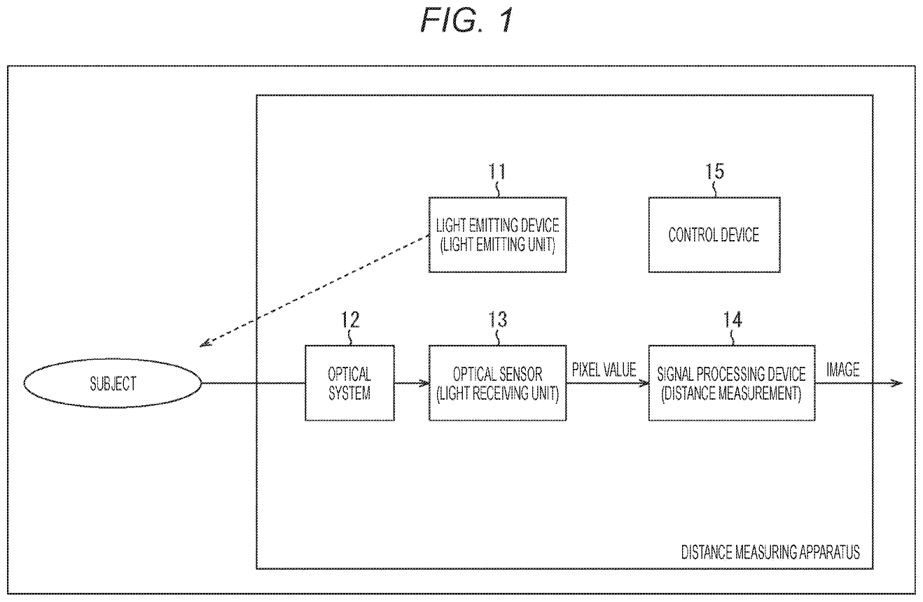

FIG. 1 is a block diagram showing a configuration example of an embodiment of a distance measuring apparatus to which the present technology is applied.

In FIG. 1, the distance measuring apparatus measures the distance to a subject (performs distance measurement), and outputs an image such as a distance image using the distance as a pixel value, for example.

In FIG. 1, the distance measuring apparatus includes a light emitting device 11, an optical system 12, an optical sensor 13, a signal processing device 14, and a control device 15.

The light emitting device 11 emits, for example, an infrared pulse having a wavelength of 850 nm or the like as irradiation light for distance measurement with the TOF method.

The optical system 12 includes optical components such as a condenser lens and an aperture, and condenses light from the subject on the optical sensor 13.

Here, the light from the subject includes reflected light that is returned from the subject when the irradiation light emitted from the light emitting device 11 is reflected on the subject. Furthermore, the light from the subject includes, for example, reflected light that is returned from the subject when light from the sun or a light source other than the light emitting device 11 is reflected on the subject and is incident on the optical system 12.

The optical sensor 13 receives light from the subject via the optical system 12, performs photoelectric conversion, and outputs a pixel value as an electric signal corresponding to light from the subject. The pixel value output from the optical sensor 13 is supplied to the signal processing device 14.

The optical sensor 13 can be configured using, for example, a complementary metal oxide semiconductor (CMOS) image sensor.

The signal processing device 14 performs predetermined signal processing using the pixel value from the optical sensor 13 to generate a distance image or the like using the distance to the subject as a pixel value, and outputs the generated image.

The control device 15 controls the light emitting device 11, the optical sensor 13, and the signal processing device 14.

Note that (one or both) of the signal processing device 14 and the control device 15 can be integrated with the optical sensor 13. In a case where the signal processing device 14 and the control device 15 are integrated with the optical sensor 13, a structure similar to that of a stacked CMOS image sensor can be adopted as the structure of the optical sensor 13, for example.

### Configuration Example of Optical Sensor 13

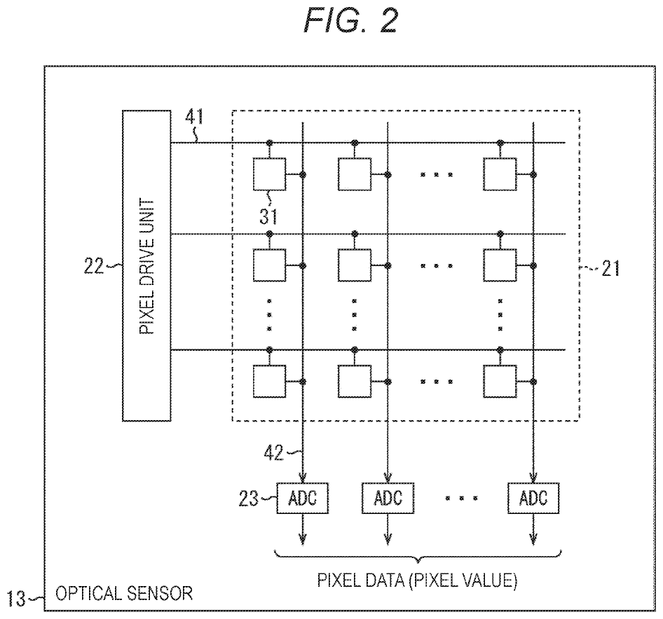

FIG. 2 is a block diagram showing an example of the electrical configuration of the optical sensor 13 shown in FIG. 1.

In FIG. 2, the optical sensor 13 includes a pixel array 21, a pixel drive unit 22, and an analog to digital converter (ADC) 23.

The pixel array 21 is formed by arranging M (length)×N (width) (M and N are integers of 1 or more and one of them is an integer of 2 or more) pixels 31 in a matrix on a two-dimensional plane, for example.

Moreover, in the pixel array, pixel control lines 41 extending in the row direction are connected to N pixels 11 arranged in the row direction (horizontal direction) on the mth row (m=1, 2, . . . , M) (from the top).

Furthermore, vertical signal lines (VSL) 12 extending in the column direction are connected to N pixels 11 arranged in the column direction (vertical direction) on the nth column (n=1, 2, . . . , N) (from the left).

The pixels 31 photoelectrically convert light (incident light) incident thereon. Moreover, the pixels 31 output a voltage (hereinafter, also referred to as a pixel signal) corresponding to the charges obtained by photoelectric conversion to the VSLs 42 according to control from the pixel drive unit 22 via the pixel control lines 41.

The pixel drive unit 22 controls (drives), via the pixel control lines 41, the pixels 31 connected to the pixel control lines 41, for example, under the control of the control device 15 or the like (FIG. 1).

The ADC 23 performs analog to digital (AD) conversion of the pixel signal (voltage) supplied from each of the pixels 31 via the VSL 42, and outputs digital data obtained as a result of the AD conversion as a pixel value (pixel data) of the pixel 31.

Note that, in FIG. 2, the ADCs 23 are provided in N columns of the pixels 31, respectively, and the ADC 23 in the nth column performs AD conversion of pixel signals of M pixels 31 arranged in the nth column.

According to the N ADCs 23 provided respectively in the N columns of the pixels 31, for example, pixel signals of the N pixels 31 arranged in one row can be simultaneously AD converted.

As described above, the AD conversion method in which an ADC is provided for each column of the pixels 31 for performing AD conversion of the pixel signals of the pixels 31 on the corresponding column is called a column parallel AD conversion method.

The AD conversion method in the optical sensor 13 is not limited to the column parallel AD conversion method. In other words, as the AD conversion method in the optical sensor 13, for example, an area AD conversion method or the like other than the column parallel AD conversion method can be adopted. In the area AD conversion method, the M×N pixels 31 are divided into pixels 31 in small areas, and an ADC is provided for each small area for performing AD conversion of the pixel signals of the pixels 31 in the corresponding small area.

### Configuration Example of Pixel 31

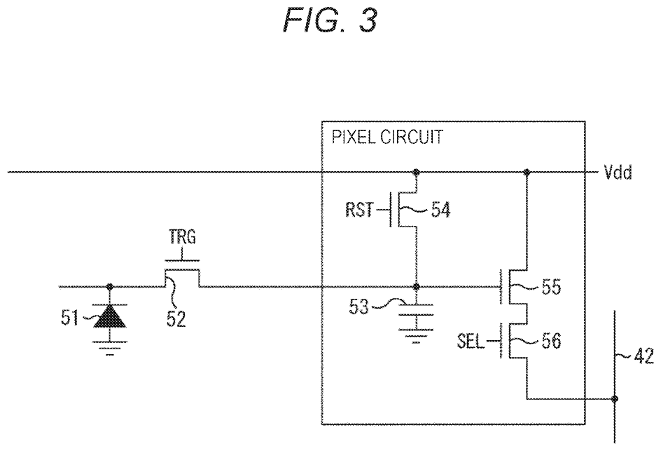

FIG. 3 is a circuit diagram showing a basic configuration example of the pixel 31 shown in FIG. 2.

In FIG. 3, the pixel 31 has a photodiode (PD) 51, four negative channel MOS (nMOS) field effect transistors (FETs) 52, 54, 55, and 56, and a floating diffusion (FD) 53.

The PD 51 which is an example of a photoelectric conversion element receives incident light incident thereon, and stores charges corresponding to the incident light.

The anode of the PD 51 is connected to the ground (grounded), and the cathode of the PD 51 is connected to the source of the PET 52.

The PET 52 is an FET for transferring the charges stored in the PD 51 from the PD 51 to the FD 53, and is hereinafter also referred to as a transfer Tr 52.

The source of the transfer Tr 52 is connected to the cathode of the PD 51, and the drain of the transfer Tr 52 is connected to the source of the FET 54 and the gate of the PET 55 via the FD 53.

Furthermore, the gate of the transfer Tr 52 is connected to the pixel control line 41, so that a transfer pulse TRG is supplied to the gate of the transfer Tr 52 via the pixel control line 41.

Here, a control signal that is supplied to the pixel control line 41 for driving (controlling) the pixel 31 by the pixel drive unit 22 (FIG. 2) via the pixel control line 41 includes the transfer pulse TRG, a reset pulse RST, and a selection pulse SEL.

The FD 53 is formed at the connection point of the drain of the transfer Tr 52, the source of the PET 54, and the gate of the PET 55, stores charges like a capacitor, and converts the charges into a voltage.

The PET 54 is a PET for resetting the charges (voltage (potential) of the FD 53) stored in the FD 53, and hereinafter also referred to as a reset Tr 54.

The drain of the reset Tr 54 is connected to a power supply Vdd.

Furthermore, the gate of the reset Tr 54 is connected to the pixel control line 41, and the reset pulse RST is supplied to the gate of the reset Tr 54 via the pixel control line 41.

The PET 55 is a PET for buffering the voltage of the PD 56, and is hereinafter also referred to as an amplification Tr 55.

The gate of the amplification Tr 55 is connected to the FD 53, and the drain of the amplification Tr 55 is connected to the power supply Vdd. Furthermore, the source of the amplification Tr 55 is connected to the drain of the PET 56.

The EST 56 is a PET for selecting an output of a signal to the VSL 42, and is hereinafter also referred to as a selection Tr 56.

The source of the selection Tr 56 is connected to the VSL 42.

Furthermore, the gate of the selection Tr 56 is connected to the pixel control line 41, and the selection pulse SEL is supplied to the gate of the selection Tr 56 via the pixel control line 41.

In the pixel 31 configured as described above, the PD 51 receives incident light incident thereon, and stores charges corresponding to the incident light.

Thereafter, the TRG pulse is supplied to the transfer Tr 52, and the transfer Tr 52 is turned on.

Here, to be precise, the voltage as the TRG pulse is constantly supplied to the gate of the transfer Tr 52, and in a case where the voltage as the TRG pulse is in a low (L) level, the transfer Tr 52 is turned off, and in a case where the voltage as the TRG pulse is in a high (H) level, the transfer Tr 52 is turned on. However, for simplifying the description, the state where the voltage as the TRG pulse in a H level is supplied to the gate of the transfer Tr 52 is described herein such that the TRG pulse is supplied to the transfer Tr 52.

When the transfer Tr 52 is turned on, the charges stored in the PD 51 are transferred to the FD 53 via the transfer Tr 52 and stored in the FD 53.

Then, a pixel signal as a voltage corresponding to the charges stored in the FD 53 is supplied to the gate of the amplification Tr 55, whereby the pixel signal is output to the VSL 42 via the amplification Tr 55 and the selection Tr 56.

Note that the reset pulse RST is supplied to the reset Tr 54 when the charges stored in the FD 53 are reset. Furthermore, the selection pulse SEL is supplied to the selection Tr 56 when the pixel signal of the pixel 31 is output to the VSL 42.

Here, in the pixel 31, the FD 53, the reset Tr 54, the amplification Tr 55, and the selection Tr 56 form a pixel circuit which converts the charges stored in the PD 51 into a pixel signal as a voltage and reads the pixel signal.

The pixel 31 can be configured to be a sharing pixel in which the PDs 51 (and transfer Trs 52) of the plurality of pixels 31 share one pixel circuit, instead of having the configuration in which the PD 51 (and the transfer Tr 52) of one pixel 31 has one pixel circuit as shown in FIG. 3.

Furthermore, the pixel 31 can be formed without having the selection Tr 56.

### First Configuration Example of Pixel Array 21

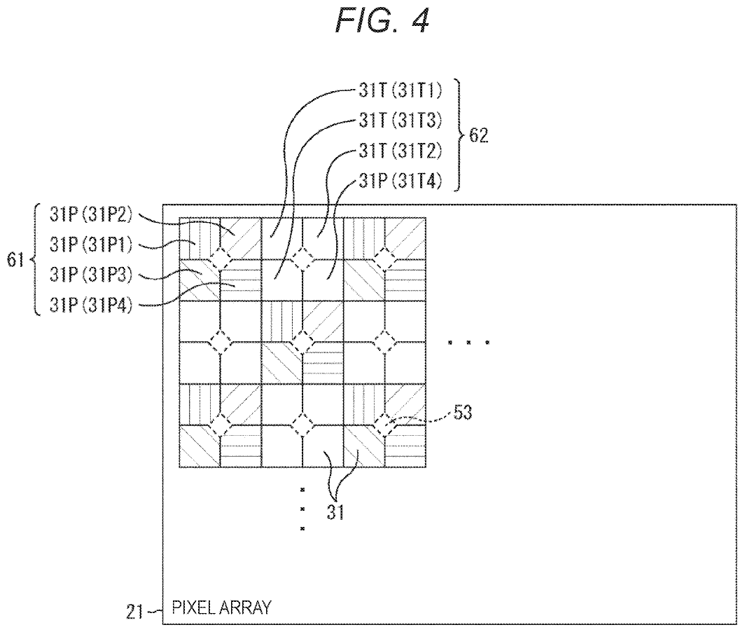

FIG. 4 is a plan view showing a first configuration example of the pixel array 21 shown in FIG. 2.

In FIG. 4, the pixel array 21 is formed by arranging the pixels 31 in a matrix on a two-dimensional plane, as described with reference to FIG. 2.

There are two types of the pixels 31 forming the pixel array 21, a polarization pixel 31P and a TOF pixel 31T.

In FIG. 4, the polarization pixel 31P and the TOF pixel 31T are formed such that the sizes of the respective light receiving surfaces (surfaces where the pixels 31 receive light) are the same.

In the pixel array 21 shown in FIG. 4, one or more of the polarization pixels 31P and one or more of the TOF pixels 31T are alternately arranged on a two-dimensional plane.

Here, when 2 (width)×2 (length) polarization pixels 318 are defined as one polarization sensor 61, and 2 (width)×2 (length) TOF pixels 31T are defined as one TOF sensor 62, the polarization sensors 61 and the TOF sensors 62 are arranged in a matrix (check pattern) in the pixel array 21 in FIG. 4.

Note that one polarization sensor 61 may be constituted by 3×3 polarization pixels 31P, 4×4 polarization pixels 31P or more, in place of 2×2 polarization pixels 31P. Furthermore, one polarization sensor 61 may be constituted by, for example, 2×3 or 4×3 polarization pixels 310 arranged in a rectangular shape, in place of, for example, 2×2 polarization pixels 310 arranged in a square shape. The same applies to the TOF sensor 62.

In FIG. 4, the upper left polarization pixel 310, the upper right polarization pixel 310, the lower left polarization pixel 310, and the lower right polarization pixel 310 in the 2×2 polarization pixels 310 forming one polarization sensor 61 are respectively referred to as polarization pixels 31P1, 31P2, 31P3, and 31P4.

Similarly, the upper left TOF pixel 31T, the upper right TOF pixel 31T, the lower left TOF pixel 31T, and the lower right TOF pixel 31T in the 2×2 TOF pixels 31T forming one TOF sensor 62 are respectively referred to as TOF pixels 31T1, 31T2, 31T3, and 31T4.

The polarization pixels 31P1, 31P2, 31P3, and 31P4 constituting one polarization sensor 61 receive, for example, light beams of different polarization planes, respectively.

Therefore, light beams of a plurality of polarization planes from the subject are respectively received by the polarization pixels 31P1, 31P2, 31P3, and 31P4 constituting one polarization sensor 61.

Note that two or more of the plurality of polarization pixels 31P among the plurality of polarization pixels 31P that constitute one polarization sensor 61 may receive light beams of the same polarization plane. For example, light beams of the same polarization plane can be received by the polarization pixels 31P1 and 31P2, and light beams of different polarization planes can be respectively received by the polarization pixels 31P3 and 31P4.

A polarizer (not shown in FIG. 4) for passing light beam of a predetermined polarization plane is formed on the light receiving surface of the polarization pixel 310. The polarization pixel 310 receives a light beam passing through the polarizer, thereby receiving the light beam of a predetermined polarization plane passing through the polarizer, and photoelectrically converting the light beam.

The polarization pixels 31P1, 31P2, 31P3, and 31P4 constituting one polarization sensor 61 are respectively provided with polarizers that allow light beams of different polarization planes to pass therethrough, whereby the polarization pixels 31P1, 31P2, 31P3, and 31P4 respectively receive light beams of different polarization planes from the subject.

In the optical sensor 13, pixel signals are read out separately from the four polarization pixels 31P1, 31P2, 31P3, and 31P4 that constitute one polarization sensor 61, and they are supplied to the signal processing device 19 as four pixel values.

On the other hand, regarding the four TOF pixels 31T1, 31T2, 31T3, and 31T4 constituting one TOF sensor 62, a value obtained by adding the pixel signals from the four TOF pixels 31T1, 31T2, 31T3, and 31T4 is read out and supplied to the signal processing device 14 as one pixel value.

The signal processing device 14 generates a distance image using the distance to the subject as a pixel value, using the pixel values (pixel signals of polarization pixels 31P1, 31P2, 31P3, and 31P4) from the polarization sensor 61 and the pixel value (the value obtained by adding the pixel signals of the TOF pixels 31T1, 31T2, 31T3, and 31T4) from the TOF sensor 62.

Note that, in FIG. 4, the four polarization pixels 31P1, 31P2, 31P3, and 31P4 that constitute one polarization sensor 61 are sharing pixels in which PDs 51 of the four polarization pixels 31P1, 31P2, 31P3, and 31P4 share the pixel circuit (FIG. 3) including the FD 53.

Similarly, the four TOF pixels 31T1, 31T2, 31T3, and 31T4 that constitute one TOF sensor 62 are sharing pixels in which the PDs 51 of the four TOF pixels 31T1, 31T2, 31T3, and 31T4 share the pixel circuit (FIG. 3) including the FD 53.

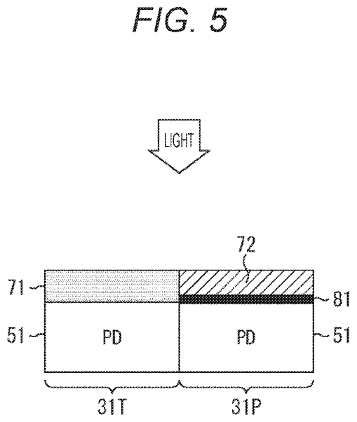

FIG. 5 is a sectional view showing a configuration example of the polarization pixel 31P and the TOF pixel 31T in the first configuration example of the pixel array 21 shown in FIG. 4.

The TOF pixel 31T receives reflected light from the subject corresponding to the irradiation light emitted from the light emitting device 11 (reflected light that is returned from the subject when the irradiation light is reflected by the subject). In the present embodiment, since an infrared pulse having a wavelength of 850 nm or the like is employed as the irradiation light as described in FIG. 1, a band pass filter (pass filter) 71 that passes (only) light, of such an infrared band is formed on the PD 51 constituting the TOF pixel 31.

The (PD 51 of) the TOF pixel 31T receives the reflected light corresponding to the irradiation light from the subject by receiving light from the subject via the band pass filter 71.

The polarization pixel 31P receives light of a predetermined polarization plane from the subject. To this end, a polarizer 81 which allows only light of a predetermined polarization plane to pass is provided on the PD 51 constituting the polarization pixel 31P.

Moreover, a cut filter 72 which cuts infrared light as reflected light corresponding to the irradiation light is formed on the polarizer 81 of the polarization pixel 31P (on the side where light is incident on the polarizer 81).

The (PD 51 of) the polarization pixel 31P receives light from the subject via the cut filter 72 and the polarizer 81, thereby receiving light, from the subject, of a predetermined polarization plane included in light other than the reflected light corresponding to the irradiation light.

In the first configuration example of the pixel array 21, the band pass filter 71 is provided on the TOF pixel 31T, and the cut filter 72 is provided on the polarization pixel 31P as described above, whereby the TOF pixel 31T can receive reflected light corresponding to the irradiation light emitted from the light emitting device 11, and the polarization pixel 31P can receive light, from the subject, other than the reflected light corresponding to the irradiation light emitted from the light emitting device 11.

Therefore, in the first configuration example of the pixel array 21, the polarization pixel 31P (the polarization sensor 61 constituted by the polarization pixel 31P) and the TOF pixel 31T (the TOF sensor 62 constituted by the TOF pixel 31T) can be simultaneously driven (the polarization pixel 31P and the TOF pixel 31T can simultaneously receive light from the subject and output pixel values corresponding to the amount of received light).

Note that, in the first configuration example of the pixel array 21, the polarization pixel 31P and the TOF pixel 31T can be driven at different timings, for example, alternately driven (the polarization pixel 31P and the TOF pixel 31T can alternately receive light from the subject and output pixel values corresponding to the amount of received light), instead of simultaneously driving the polarization pixel 31P and the TOF pixel 31T.

Meanwhile, in the optical sensor 31, pixel signals are read out separately from the four polarization pixels 31P1, 31P2, 31P3, and 31P4 that constitute one polarization sensor 61, and they are supplied to the signal processing device 14 as four pixel values.

Furthermore, regarding the four TOF pixels 31T1, 31T2, 31T3, and 31T4 constituting one TOF sensor 62, a value obtained by adding the pixel signals from the four TOF pixels 31T1, 31T2, 31T3, and 31T4 is read out and supplied to the signal processing device 14 as one pixel value.

The signal processing device 14 calculates the relative distance to the subject by the polarization method using the pixel values (pixel signals of the polarization pixels 31P1, 31P2, 31P3, and 31P4) from the polarization sensor 61.

Furthermore, the signal processing device 14 calculates the absolute distance to the subject by the TOF method using the pixel value (value obtained by adding the pixel signals of the TOF pixels 31T1, 31T2, 31T3, and 31T4) from the TOF sensor 62.

Then, the signal processing device 14 corrects the absolute distance to the subject calculated by the TOF method using the relative distance to the subject calculated by the polarization method, and generates a distance image using the corrected distance as a pixel value. The absolute distance calculated by the TOF method is corrected such that, for example, the amount of change with respect to the position of the absolute distance calculated by the TOF method matches the relative distance calculated by the polarization method.

Here, in the polarization method, by using the fact that the polarization state of light from the subject differs depending on the surface direction of the subject, the normal direction of the subject is obtained using the pixel values corresponding to light beams of a plurality of (different) polarization planes from the subject, and relative distances to respective points of the subject based on an arbitrary point of the subject are calculated from the obtained normal direction.

In the TOF method, the distance to the subject from the distance measuring apparatus is calculated as the absolute distance to the subject by obtaining the flight time from the emission of the irradiation light to the reception of the reflected light corresponding to the irradiation light, that is, the phase difference between the pulse as the irradiation light and the pulse as the reflected light corresponding to the irradiation light, as described above.

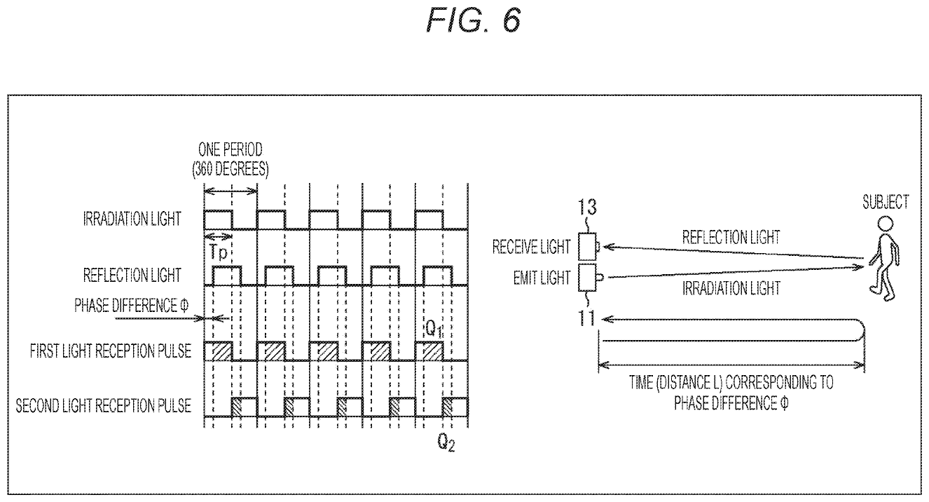

FIG. 6 is a diagram for describing the principle of distance calculation with the TOF method.

Here, the irradiation light is, for example, a pulse having a predetermined pulse width Tp, and in order to simplify the description, it is assumed that the period of the irradiation light is 2×Tp.

The TOF sensor 62 of the optical sensor 13 receives reflected light corresponding to the irradiation light (reflected light when the irradiation light is reflected on the subject) when the flight time Δt according to the distance L to the subject has elapsed after the irradiation light is emitted.

Now, a pulse having a pulse width and a phase same as those of the pulse of the irradiation light is referred to as a first light reception pulse, and a pulse having a pulse width same as that of the pulse of the irradiation light and having a pulse width shifted by the pulse width Tp (190 degrees) is referred to as a second light reception pulse.

In the TOF method, the reflected tight is received in each of the (H level) period of the first light reception pulse and the period of the second light reception pulse.

Now, the charge amount (amount of received light) of the reflected light received in the period of the first light reception pulse is represented as Q₁, and the charge amount of the reflected right received in the period of the second light reception pulse is represented as Q₂.

In this case, the flight time Δt can be obtained according to the equation. Δt=Tp×Q₂/(Q₁+Q₂). Note that the phase difference φ between the irradiation light and the reflected light corresponding to the irradiation light is represented by the equation φ=180 degrees×Q₂/Q₁+Q₂).

The flight time Δt is proportional to the charge amount Q₂, and therefore, in a case where the distance L to the subject is shorter, the charge amount Q₂ becomes smaller, and in a case where the distance L to the subject is longer, the charge amount Q₂ becomes greater.

Meanwhile, in the distance measurement using the TOF method, a light source such as the light emitting device 11 which emits the irradiation light is essential, and in a case where there is light stronger than the irradiation light emitted by the light source, the accuracy of the distance measurement is decreased.

Furthermore, as a method of maintaining the accuracy of distance measurement in measuring a long distance, the TOF method includes a method of increasing the intensity of irradiation light and a method of extending an integration period for integrating pixel signals (light reception signals). However, such methods cause an increase in power consumption.

Moreover, in the distance measurement with the TOF method, the distance to the subject is calculated using an amount of reflected light received during the period of the first light reception pulse having the same phase as the irradiation light and an amount of reflected light received during the period of the second light reception pulse having a phase shifted from the phase of the irradiation light by 180 degrees. Thus, the distance measurement with the TOF method needs AD conversion between a pixel signal corresponding to the amount of reflected light received during the period of the first light reception pulse and a pixel signal corresponding to the amount of reflected light received during the period of the second light reception pulse. Accordingly, in the distance measurement with the TOF method, the number of times of AD conversion needs to be twice the number of times of AD conversion in a case where an image is captured by receiving visible light (hereinafter, also referred to as normal image capture), and thus, the distance measurement with the TOF method simply requires twice as much time as the distance measurement with the stereo vision method or the structured light method in which the similar number of times of AD conversion to the normal image capture is only required.

As described above, distance measurement with the TOF method requires more time compared to distance measurement with the stereo vision method or the structured light method.

Furthermore, in the TOF method, the distance is likely to be erroneously detected for, for example, a subject on which specular reflection occurs, such as a mirror or water surface.

Moreover, in the TOF method, in a case where non-visible light such as infrared light is used as irradiation light, it is difficult, to obtain, for example, a color image such as red, green, and blue (RGB) by performing normal image capture simultaneously with the distance measurement with the TOF method.

On the other hand, the distance measuring apparatus shown in FIG. 1 includes the optical sensor 13 which has the polarization pixels 31P used for the distance measurement with the polarization method and the TOF pixels 31T used for the distance measurement with the TOF method, and the polarization pixels 31P and the TOF pixels 31T are arranged in a matrix in units of the polarization sensor 61 constituted by 2×2 polarization pixels 31P and the TOF sensor 62 constituted by 2×2 TOF pixels 31T.

Moreover, in the distance measuring apparatus shown in FIG. 1, the signal processing device 14 calculates the relative distance to the subject with the polarization method using the pixel values (pixel signals of the polarization pixels 31P1, 31P2, 31P3, and 31P4) from the polarization sensor 61, and calculates the absolute distance to the subject with the TOF method using the pixel value (the value obtained by adding the pixel signals of the TOF pixels 31T1, 31T2, 31T3, and 31T4) from the TOF sensor 62, as described with reference to FIGS. 4 and 5.

Then, the signal processing device 14 corrects the absolute distance to the subject calculated by the TOF method using the relative distance to the subject calculated by the polarization method, and generates a distance image using the corrected distance as a pixel value.

Therefore, it is possible to suppress a decrease in the accuracy of distance measurement without increasing power consumption. In other words, a decrease in the measurement accuracy in measuring a long distance with the TOF method can be particularly suppressed by correcting the result of distance measurement with the TOF method using the result of distance measurement with the polarization method.

Furthermore, in the distance measurement with the polarization method, irradiation light is not required, unlike the distance measurement with the TOF method. Therefore, even in a case where the accuracy of the distance measurement with the TOF method is decreased by, for example, an influence of light other than the irradiation light, such as sunlight, during distance measurement outdoors, a decrease in the measurement accuracy can be suppressed by correcting the result of distance measurement with the TOF method using the result of distance measurement with the polarization method.

Moreover, since the power consumption in the distance measurement with the polarization method is lower than the power consumption in the distance measurement with the TOF method, low power consumption and high resolution of distance images can be both achieved by, for example, decreasing the number of the TOF pixels 31T constituting the optical sensor 13 and increasing images of the polarization pixels 31P.

Furthermore, it is likely with the TOF method that the distance is erroneously detected for a subject on which specular reflection occurs, such as a mirror or a water surface, while the polarization method makes it possible to accurately calculate the (relative) distance for such a subject. Therefore, a decrease in the measurement accuracy for a subject on which specular reflection occurs can be suppressed by correcting the result of distance measurement with the TOF method using the result of distance measurement with the polarization method.

Moreover, in a case where only the polarization pixel 31P is arranged to constitute a first optical sensor, and only the TOF pixel 31T is arranged to constitute a second optical sensor, coordinates of pixels of the same subject are deviated between the first and second optical sensors according to a difference in installation positions of the first and second optical sensors. In contrast, in the optical sensor 13 constituted by (the polarization sensor 61 constituted by) the polarization pixel 31P and (the TOF sensor 62 constituted by) the TOF pixel 31T, coordinate deviation occurring between the first and second optical sensors does not occur. Therefore, in the signal processing device 14, signal processing can be performed without considering such coordinate deviation.

Furthermore, in the optical sensor 13 constituted by the polarization pixel 31P and the TOF pixel 31T, even when, for example, light of red (R), green (G), and blue (B) is received by the polarization pixel 31P, the reception of such light does not affect the accuracy of the distance measurement. Therefore, when the optical sensor 13 is configured such that light beams of R, G, and B are received, as appropriate, by a plurality of polarization pixels 31P, respectively, a color image similar to that obtained by normal image capture can be obtained by the optical sensor 13 simultaneously with the distance measurement.

Moreover, the polarization pixel 31P can be configured by forming the polarizer 81 on a pixel that performs normal image capture. Therefore, in the polarization method using the pixel value of the polarization pixel 31P, the relative distance to the subject can be obtained quickly by increasing the frame rate, as in the stereo vision method or the structured light method. Accordingly, due to the configuration is which the absolute distance to the subject calculated with the TOF method is corrected using the relative distance to the subject calculated with the polarization method, it is possible to compensate for the distance measurement with the TOF method which requires more time, and to enable high-speed distance measurement.

Furthermore, although the value obtained by adding the pixel signals of four TOF pixels 31T1 to 31T4 constituting the TCP sensor 62 is read as one pixel value in the TCF sensor 62 in the present embodiment, a pixel signal can be read from each of the four TOF pixels 31T1 to 31T4 constituting the TOF sensor 62. In this case, the resolution of distance measurement with the TOF method is improved, and thus, the resolution of the distance obtained by correcting the absolute distance to the subject calculated with the TOF method using the relative distance to the subject calculated with the polarization method can be improved.

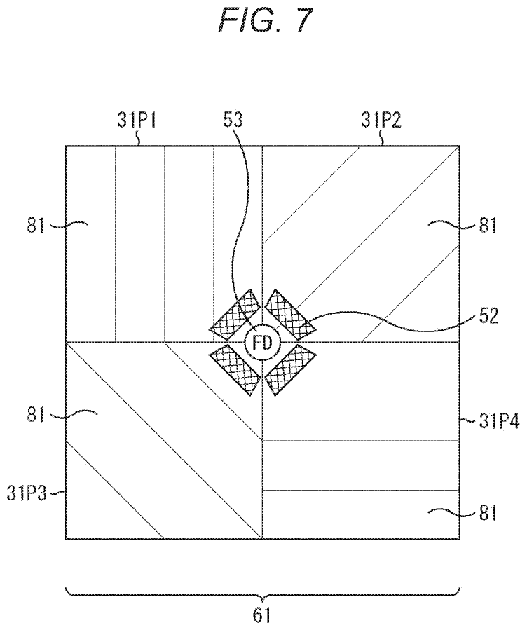

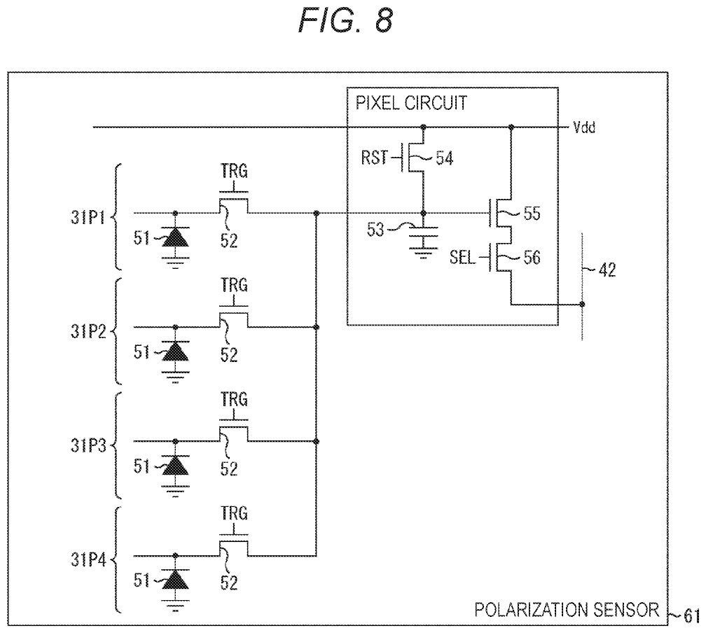

FIG. 7 is a plan view showing a configuration example of the polarization sensor 61 shown in FIG. 4. FIG. 8 is a circuit diagram showing an electric configuration example of the polarization sensor 61 shown in FIG. 4.

As shown in FIG. 7, polarizers 81 are respectively formed on the light receiving surfaces of the four polarization pixels 31P1 to 31P4 constituting the polarization sensor 61. The polarizers 81 on the respective polarization pixels 31P1 to 31P4 transmit light beams of different polarization planes.

Furthermore, the four polarization pixels 31P1 to 31P4 constituting the polarization sensor 61 share a pixel circuit including the FD 53 as shown in FIG. 8

In other words, the PDs 51 of the polarization pixels 31P1 to 31P4 are connected to one FD 53 shared by the polarization pixels 31P1 to 31P4 via the transfer Trs 52 of the polarization pixels 31P1 to 31P4.

As shown in FIG. 7, the FD 53 shared by the polarization pixels 31P1 to 31P4 is disposed at the center of the (polarization sensor 61 constituted by the) 2 (width)×2 (length) polarization pixels 31P1 to 31P4.

In the polarization sensor 61 configured as described above, the transfer Trs 52 of the polarization pixels 31P1 to 31P4 are sequentially turned on. Thus, the pixel signals of the polarization pixels 31P1 to 31P4 (pixel signals respectively corresponding to amounts of light beams of different polarization planes received by the PDs 51 of the polarization pixels 31P1 to 31P4) are sequentially read.

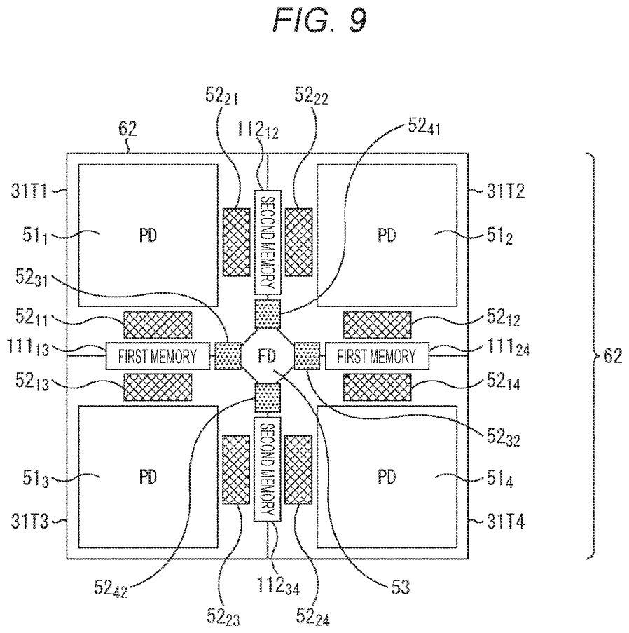

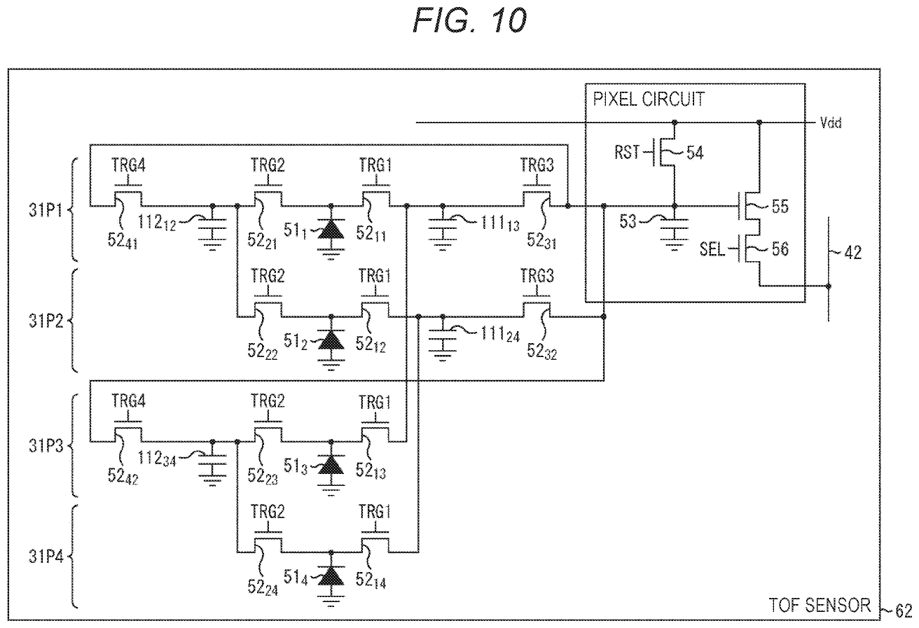

FIG. 9 is a plan view showing a configuration example of the TOF sensor 62 shown in FIG. 4. FIG. 10 is a circuit diagram showing an electric configuration example of the TOF sensor 62 shown in FIG. 4.

Here, for the TOF sensor 62, the PDs 51 of the TOF pixels 31T1 to 31T4 constituting the TOF sensor 62 will also be referred to as PD 51₁, PD 51₂, PD 51₃, and PD 51₄, respectively.

The TOF pixel 31T#i (#i=1, 2, 3, 4) has two FETs which are a first transfer Tr 52_{1#i} and a second transfer Tr 52_{2#i} as the transfer Tr 52 as shown in FIGS. 9 and 10.

Moreover, the TOF sensor 62 further has two third transfer Trs 52₃₁ and 52₃₂, two fourth transfer Trs 52₄₁ and 52₄₂, two first memories 111₁₃ and 111₂₄, and two second memories 112₁₂ and 112₃₄ in addition to the TOF pixels 31T1 to 31T4, as shown in FIGS. 9 and 10.

Note that, in FIG. 10, the transfer pulse TRG supplied to the gate of the jth transfer Tr 52_{#j#i} is illustrated as TRG#j (#j=1, 2, 3, 4). The transfer pulse TRG#j having the same #j is the same transfer pulse.

The PD 51₁ of the TOF pixel 31T1 is connected to the first memory 111₁₃ via the first transfer Tr 52₁₁.

Moreover, the PD 51₁ of the TOF pixel 31T1 is also connected to the second memory 112₁₂ via the second transfer Tr 52₂₁.

The PD 51₂ of the TOF pixel 31T2 is connected to the first memory 111₂₄ via the first transfer Tr 52₁₂.

Moreover, the PD 51₂ of the TOF pixel 31T2 is also connected to the second memory 112₁₂ via the second transfer Tr 52₂₂.

The PD 51₃ of the TOF pixel 31T3 is connected to the first memory 111₁₃ via the first transfer Tr 52₁₃.

Moreover, the PD 51₃ of the TOF pixel 31T3 is also connected to the second memory 112₃₄ via the second transfer Tr 52₂₃.

The PD 51₄ of the TOF pixel 31T4 is connected to the first memory 111₂₄ via the first transfer Tr 52₁₄.

Moreover, the PD 51₄ of the TOF pixel 31T4 is also connected to the second memory 112₃₄ via the second transfer Tr 52₂₄.

The first memory 111₁₃ is connected to the FD 53 via the third transfer Tr 52₃₁, and the first memory 111₂₄ is connected to the FD 53 via the third transfer Tr 52₃₂.

The second memory 112₁₂ is connected to the FD 53 via the fourth transfer Tr 52₄₁, and the second memory 112₃₄ is connected to the FD 53 via the fourth transfer Tr 52₄₂.

In the TOF sensor 62 configured as described above, the value obtained by adding the pixel signals of the TOF pixels 31T1 to 31T4 (pixel signals respectively corresponding to amounts of light received by the PD 51₁ to PD 51₄ of the TOF pixels 31T1 to 31T4) is read as one pixel signal.

In other words, in the TOF sensor 62, the first transfer Tr 52_{1#i} and the second transfer Tr 52₃₃ are alternately turned on.

When the first transfer Tr 52_{1#i} is turned on, charges stored in the PD 51₁ and charges stored in the PD 51₃ are transferred to the first memory 111₁₃ via the first transfer Trs 52₁₁ and 52₁₃, respectively, and added, and charges stored in the PD 51₂ and charges stored in the PD 51₄ are transferred to the first memory 111₂₄ via the first transfer Trs 52₁₂ and 52₁₄, respectively, and added.

On the other hand, when the second transfer Tr 52_{2#i} is turned on, charges stored in the PD 51₁ and charges stored in the PD 51₂ are transferred to the second memory 112₁₂ via the second transfer Trs 52₂₁ and 52₂₂, respectively, and added, and charges stored in the PD 51₃ and charges stored in the PD 51₄ are transferred to the second memory 112₃₄ via the second transfer Trs 52₂₃ and 52₂₄, respectively, and added.

After the on/off of the first transfer Tr 52_{1#i} and the second transfer Tr 52_{2#i} is repeated a predetermined number of times, the third transfer Trs 52₃₁ and 52₃₂ are turned on at a rang when the fourth transfer Trs 52₄₁ and 52₄₂ are not on, whereby charges stored in the first memories 111₁₃ and 111₂₄ are transferred to the FD 53 via the third transfer Trs 52₃₁ and 52₃₂, respectively, and added.

Thus, the FD 53 stores the added value of the charges transferred from the PDS 51₁ to 51₄ when the first transfer Trs 52₁₁ to 52₁₄ are turned on, and the voltage corresponding to the added value is read as, for example, the pixel signal corresponding to the amount, of charges of the reflected light received during the period of the first light reception pulse described with reference to FIG. 6.

Moreover, after the on/off of the first, transfer Tr 52_{1#i} and the second transfer Tr 52_{2#1} is repeated a predetermined number of times, the fourth transfer Trs 52₄₁ and 52₄₂ are turned on at a timing when the third transfer Trs 52₃₁ and 52₃₂ are not on, whereby charges stored in the second memories 112₁₂ and 112₃₄ are transferred to the FD 53 via the fourth transfer Trs 52₄₁ and 52₄₂, respectively, and added.

Thus, the FD 53 stores the added value of the charges transferred from the PDs 51₁ to 51₄ when the second transfer Trs 52₂₁ to 52₂₄ are turned on, and the voltage corresponding to the added value is read as, for example, the pixel signal corresponding to the amount, of charges of the reflected light received during the period of the second light reception pulse described with reference to FIG. 6.

Note that, in the TOF sensor 62, a potential can be applied to the first memories 111₁₃ and 111₂₄ and the second memories 112₁₂ and 112₃₄ so that the charges flow.

Furthermore, the polarization pixel 31P and the TOF pixel 31T can be configured such that one PD 51 uses one pixel circuit, without being configured to be sharing pixels.

### Second Configuration Example of Pixel Array 21

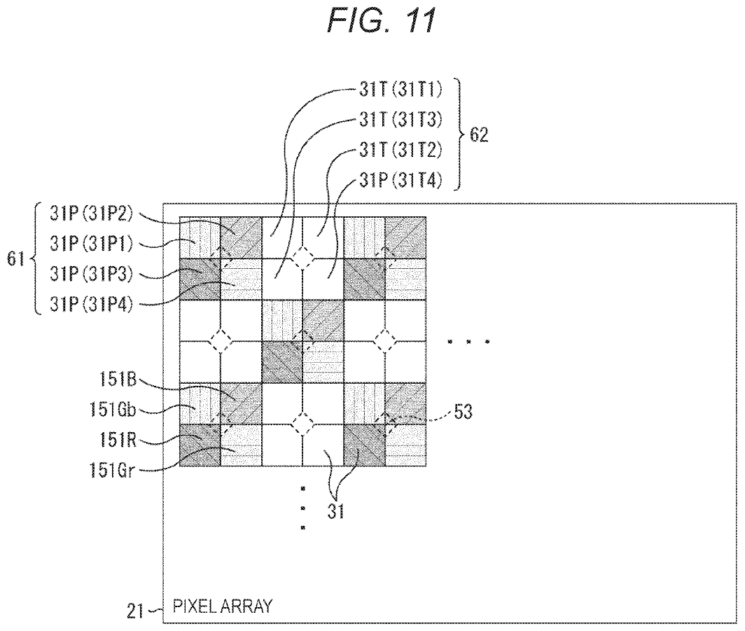

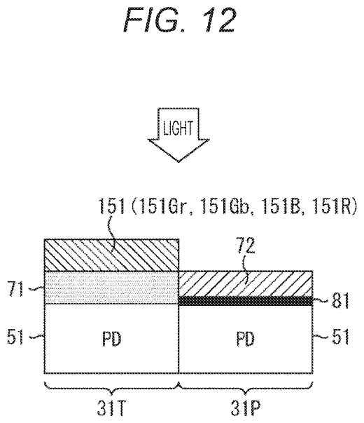

FIG. 11 is a plan view showing a second configuration example of the pixel array 21 shown in FIG. 2. FIG. 12 is a sectional view showing a configuration example of the polarization pixel 31P and the TOF pixel 31T in the second configuration example of the pixel array 21 shown in FIG. 11.

Note that the parts in FIGS. 11 and 12 corresponding to those in FIGS. 4 and 5 are denoted by the same reference signs, and the description thereof will be omitted below as appropriate.

In FIGS. 11 and 12, a color filter 151 is formed on the band pass filter 71 of the polarization pixel 31P, and the second configuration example of the pixel array 21 is different from the configuration example shown in FIGS. 4 and 5 in that the color filter 151 is formed.

In FIGS. 11 and 12, as the color filter 151, a color filter 151R for passing R light, color filters 151Gr and 151Gb for passing G light, and a color filter 151B for passing B light are formed in a Bayer pattern on the polarization pixels 31P1 to 31P4 constituting the polarization sensor 61.

In other words, the color filter 151Gb is formed on the polarization pixel 31P1, the color filter 151B is formed on the polarization pixel 31P2, the color filter 151R is formed on the polarization pixel 31P3, and the color filter 151Gr is formed on the polarization pixel 31P4, for example.

As described above, in a case where the color filter 151 is formed on the polarization pixel 31P, a color image can be formed using the pixel value of the polarization pixel 31P. As a result, it is possible to simultaneously obtain a color image and a distance image representing the distance to the subject included in the color image.

Note that, in the first configuration example of the pixel array 21 shown in FIGS. 4 and 5, the color filter 151 is not provided on the polarization pixel 31P, so it is difficult to form a color image. However, a monochrome image can be formed using the pixel value of the polarization pixel 31P. Moreover, since the color filter 151 is not provided on the polarization pixel 31P in the first configuration example of the pixel array 21, the sensitivity is improved, that is, the amount of light received during the same period can be increased, as compared to the case where the color filter 151 is provided. Thus, the S/N can be improved.

### Third Configuration Example of Pixel Array 21

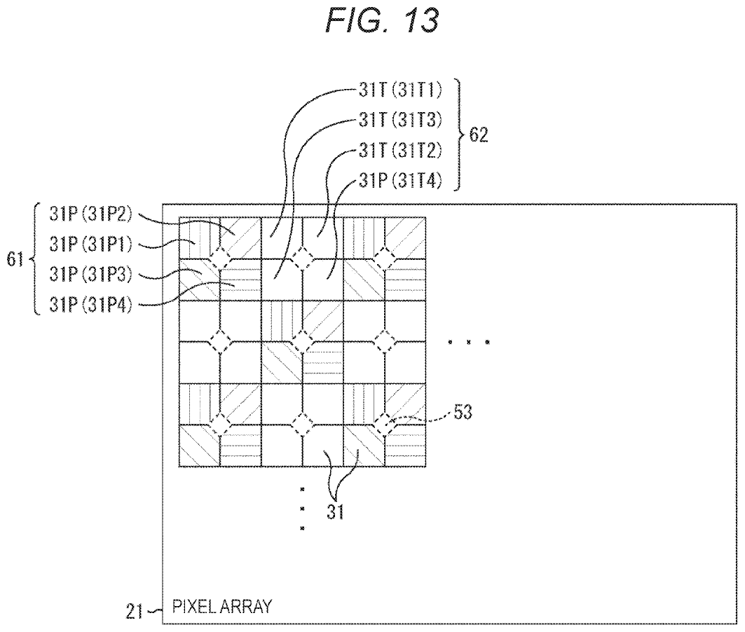

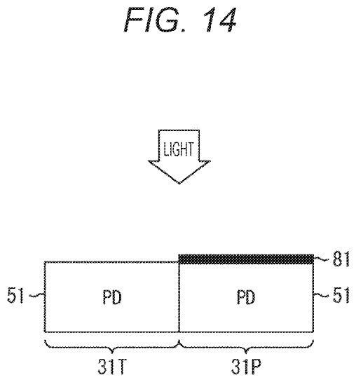

FIG. 13 is a plan view showing a third configuration example of the pixel array 21 shown in FIG. 2. FIG. 14 is a sectional view showing a configuration example of the polarization pixel 31P and the TOF pixel 31T in the third configuration example of the pixel array 21 shown in FIG. 13.

Note that the parts in FIGS. 13 and 14 corresponding to those in FIGS. 4 and 5 are denoted by the same reference signs, and the description thereof will be omitted below as appropriate.

The third configuration example of the pixel array 21 is different from the configuration example shown in FIGS. 4 and 5 in that the band pass filter 71 is not provided on the polarization pixel 31P and the cut filter 72 is not provided on the TOF pixel 31T.

In the third configuration example of the pixel array 21, the polarization pixel 31P and the TOF pixel 31T are driven at different timings in order that reflected light corresponding to the infrared light used as the irradiation light in the TOF method is not received by the polarization pixel 31P (in order that the pixel value corresponding to the reflected light is not output). In other words, the polarization pixel 31P and the TOF pixel 31T are driven alternately, for example (the light emitting device 11 emits irradiation light when the TOF pixel 31T is driven).

As described above, due to the configuration in which the polarization pixel 31P and the TOF pixel 31T are alternately driven, the reflected light corresponding to the infrared light used as the irradiation light in the TOF method is prevented from being received by the polarization pixel 31P, whereby the accuracy in distance measurement is improved, and power consumption can be reduced.

Note that the third configuration example of the pixel array 21 is particularly useful for measuring a distance to, for example, a subject which does not move fast.

### Fourth Configuration Example of Pixel Array 21

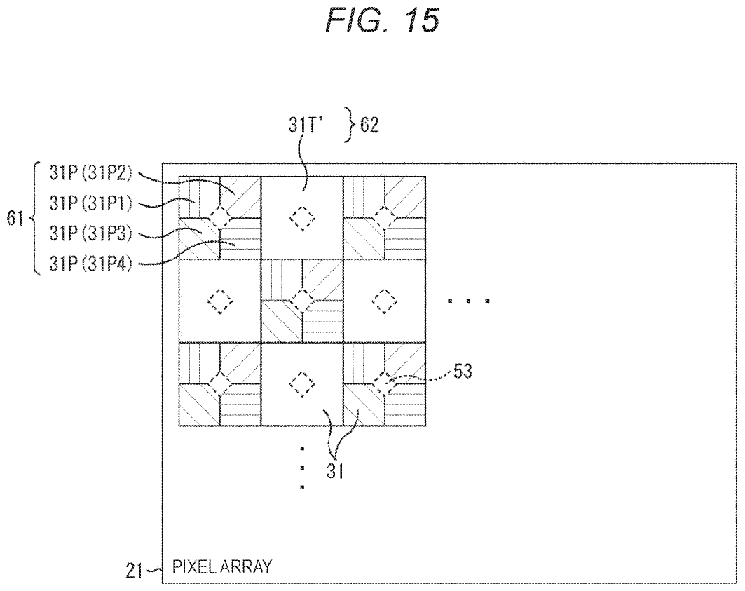

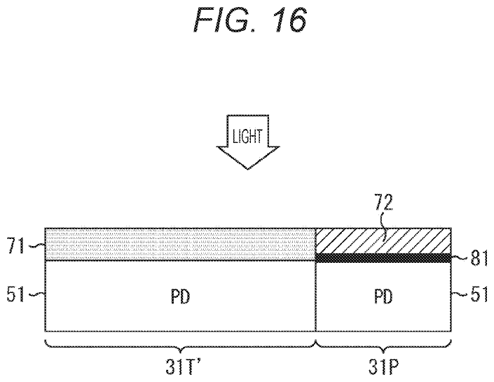

FIG. 15 is a plan view showing a fourth configuration example of the pixel array 21 shown in FIG. 2. FIG. 16 is a sectional view showing a configuration example of the polarization pixel 31P and the TOF pixel 31T in the fourth configuration example of the pixel array 21 shown in FIG. 15.

Note that the parts in FIGS. 15 and 16 corresponding to those in FIGS. 4 and 5 are denoted by the same reference signs, and the description thereof will be omitted below as appropriate.

In FIGS. 15 and 16, the TOF sensor 62 is constituted by one large TOF pixel 31T′, instead of the four TOF pixels 31T (31T1 to 31T4) , and the fourth configuration example of the pixel array 21 is different in that point from the configuration example in FIGS. 4 and 5 where the TOF sensor 62 is constituted by four small TOF pixels 31T.

In FIGS. 4 and 5, the polarization pixel 31P and the TOF pixel 31T are formed such that the sizes of the respective, light receiving surfaces are the same. However, in the fourth configuration example of the pixel array 21, the TOF pixel 31T′ is formed to have a light receiving surface larger than that of the TOF pixel 31T, that is, the polarization pixel 31P.

In other words, (the light receiving surface of) the TOF pixel 31T′ has the same size as the size corresponding to 2×2 polarization pixels 31P or 2×2 TOF pixels 31T.

In the TOF pixel 31T′ having a large light receiving surface, the sensitivity is improved, that is, an amount of light received during the same period is increased, as compared with the TOF pixel 31T having a small light receiving surface. Therefore, even when the light receiving time (exposure time) is decreased, that is, even when the TOF pixel 31T′ is driven at high speed, the S/N similar to that of the TOF pixel 31T can be maintained.

However, in the TOF pixel 31T′ having a large light receiving surface, the resolution is lowered as compared with the case where one pixel value is output from the TOF pixel 31T having a small light receiving surface.

As described above, the TOF pixel 31T′ can be driven at high speed, but the resolution is lowered.

However, when the absolute distance to the subject calculated from the pixel value of the large TOF pixel 31T′ with the TOF method is corrected using the relative distance to the subject calculated from the pixel value of the small polarization pixel 31P with the polarization method, it is possible to compensate for a decrease in resolution caused by the application of the large TOF pixel 31T′, and to achieve an increase in speed and an increase is resolution in the distance measurement.

### Fifth Configuration Example of Pixel Array 21

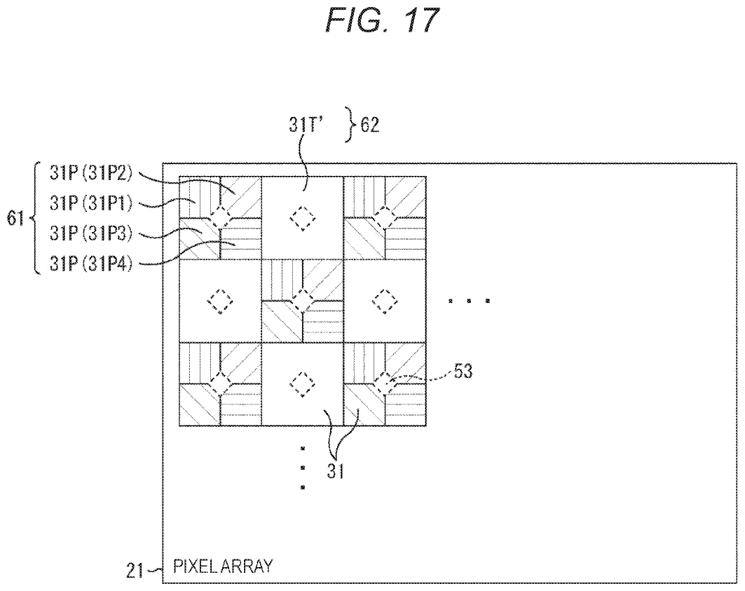

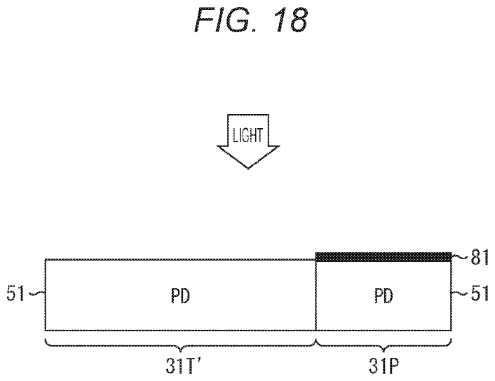

FIG. 17 is a plan view showing a fifth configuration example of the pixel array 21 shown in FIG. 2. FIG. 18 is a sectional view showing a configuration example of the polarization pixel 31P and the TOF pixel 31T in the fifth configuration example of the pixel array 21 shown in FIG. 17.

Note that the parts in FIGS. 17 and 18 corresponding to those in FIGS. 15 and 16 are denoted by the same reference signs, and the description thereof will be omitted below as appropriate.

The fifth configuration example of the pixel array 21 is different from the configuration example shown in FIGS. 15 and 16 in that the band pass filter 71 is not provided on the polarization pixel 31P and the cut filter 72 is not provided on the TOF pixel 31T′.

In the fifth configuration example of the pixel array 21, the polarization pixel 31P and the TOF pixel 31T′ are driven at different timings, that is, driven alternately, for example, in order that reflected light corresponding to the infrared light used as the irradiation light in the TOF method is not received by the polarization pixel 31P, as in the third configuration example.

Therefore, in the fifth configuration example of the pixel array 21, the reflected light corresponding to the infrared light used as the irradiation light in the TOF method is prevented from being received by the polarization pixel 31P as in the third configuration example, whereby the accuracy in distance measurement is improved. Moreover, power consumption can be reduced in the fifth configuration example of the pixel array 21.

Note that the fifth configuration example of the pixel array 21 is useful for measuring a distance to a subject which does not move fast, as in the third configuration example.

### Example of Application to Mobile Body

The technology according to the present disclosure (present technology) is applicable to various products. For example, the technology according to the present. disclosure may be implemented as a device to be mounted on any type of mobile bodies such as vehicles, electric vehicles, hybrid electric vehicles, motorcycles, bicycles, personal mobility, airplanes, drones, ships, and robots.

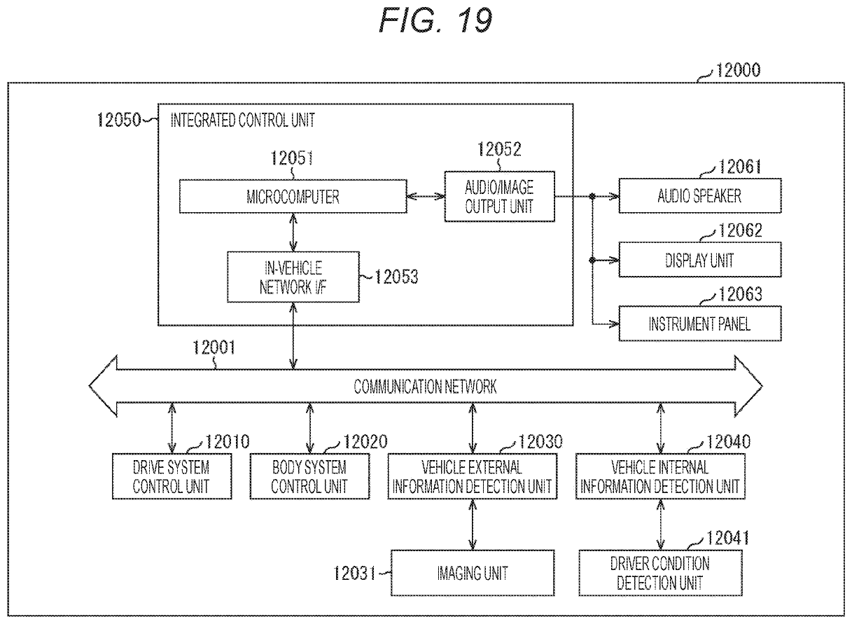

FIG. 19 is a block diagram showing a schematic configuration example of a vehicle control system which is an example of a mobile body control system to which the technology according to the present disclosure can be applied.

A vehicle control system 12000 includes a plurality of electronic control units connected to each other via a communication network 12001. In the example shown in FIG. 19, the vehicle control system 12000 includes a drive system control unit 12010, a body system control unit 12020, a vehicle external information detection unit 12030, a vehicle internal information detection unit 12040, and an integrated control unit 12050. Furthermore, as a functional configuration of the integrated control unit 12050, a microcomputer 12051, an audio/image output unit 12052, and an in-vehicle network interface (I/F) 12053 are illustrated.

The drive system control unit 12010 controls the operation of devices related to a vehicle drive system according to various programs. For example, the drive system control unit 12010 functions as a controller over a driving force generating device such as an internal combustion engine or a driving motor for generating a driving force of the vehicle, a driving force transmission mechanism for transmitting the driving force to wheels, a steering mechanism adjusting a steering angle of the vehicle, a braking device that generates a braking force of the vehicle, and the like.

The body system control unit 12020 controls the operation of various kinds of devices provided to the vehicle body in accordance with various kinds of programs. For example, the body system control unit 12020 functions as a controller for a keyless entry system, a smart key system, a power window device, or various kinds of lamps such as a headlamp, a backup lamp, a brake lamp, a turn signal, or a fog lamp. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The vehicle external information detection unit 12030 detects information regarding the outside of the vehicle on which the vehicle control system 12000 is mounted. For example, the imaging unit 12031 is connected to the vehicle external information detection unit 12030. The vehicle external information detection unit 12030 causes the imaging unit 12031 to capture an image outside the vehicle, and receives the captured image. The vehicle external information detection unit 12030 may perform an object detection process for detecting an object such as a person, another vehicle, an obstacle, a sign, or a character on the road surface, or a distance detection process, on the basis of the received image.

The imaging unit 12031 is an optical sensor that receives light and outputs an electric signal according to the amount of received light. The imaging unit 12031 can also output an electric signal as an image or as information for the distance measurement. Furthermore, light received by the imaging unit 12031 may be visible light or non-visible light such as infrared light.

The vehicle internal information detection unit. 12040 detects information regarding the inside of the vehicle. For example, a driver condition detection unit 12041 that detects a condition of a driver is connected to the vehicle internal information detection unit 12040. The driver condition detection unit 12041 includes, for example, a camera for capturing an image of the driver, and the vehicle internal information detection unit 12040 may determine the degree of fatigue or the degree of concentration of the driver or may determine whether the driver is dozing off, on the basis of the detection information input from the driver condition detection unit 12041.

The microcomputer 12051 calculates a control target value of the driving force generating device, the steering mechanism, or the braking device on the basis of the information regarding the outside of the vehicle acquired by the vehicle external information detection unit 12030 or the information regarding the inside of the vehicle acquired by the vehicle internal information detection unit 12040, and can output a control command to the drive system control unit 12010. For example, the microcomputer 12051 may perform cooperative control intended to implement functions of an advanced driver assistance system (ADAS) including collision avoidance or shock mitigation for the vehicle, follow-up traveling based on distance between vehicles, vehicle speed maintaining driving, a warning of collision of the vehicle, a warning of lane departure of the vehicle, or the like.

Furthermore, the microcomputer 12051 may perform cooperative control intended for automatic driving, which makes the vehicle to travel autonomously without depending on the drive's operation, or the like, by controlling the driving force generating device, the steering mechanism, the braking device, and the like on the basis of the information regarding the surrounding situation of the vehicle acquired by the vehicle external information detection unit 12030 or the vehicle internal information detection unit 12040.

Furthermore, the microcomputer 12051 can output a control command to the body system control unit 12020 on the basis of the information regarding the outside of the vehicle acquired by the vehicle external information detection unit 12030. For example, the microcomputer 12051 is capable of performing cooperative control to prevent dazzle by controlling the head lamp according to the position of a preceding vehicle or an oncoming vehicle detected by the vehicle external information detection unit 12030 and switching from high beams to low beams, for example.

The audio/image output unit 12052 transmits an output signal of at least one of audio or images to output devices capable of visually or audibly notifying an occupant of the vehicle or the outside of the vehicle of information. In the example in FIG. 19, an audio speaker 12061, a display unit 12062, and an instrument panel 12063 are illustrated as the output devices. The display unit 12062 may include, for example, at least one of an on-hoard display or a head-up display.

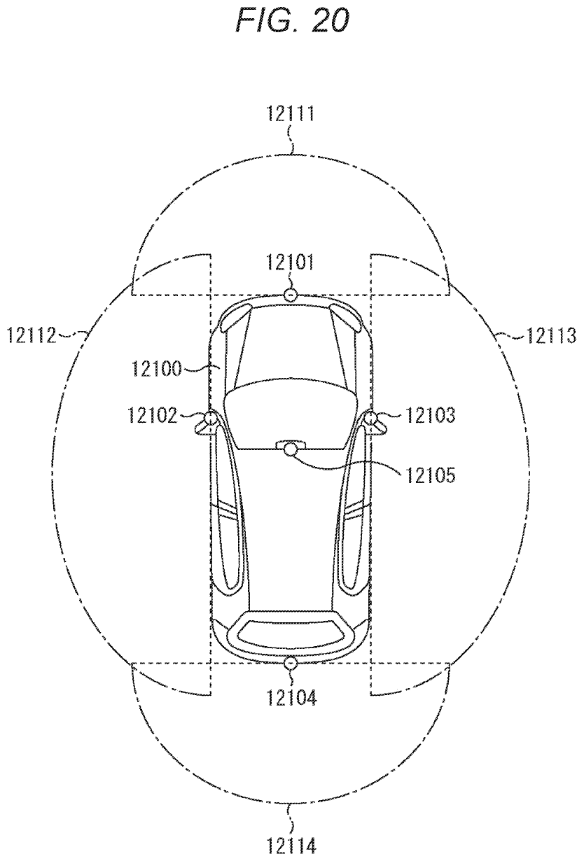

FIG. 20 is a diagram illustrating an exemplary position where the imaging unit 12031 is mounted.

In FIG. 20, a vehicle 12100 includes imaging units 12101, 12102, 12103, 12104, and 12105 as the imaging unit 12031.

For example, the imaging units 12101, 12102, 12103, 12104, and 12105 are mounted in respective positions of the vehicle 12100 such as a front nose, side mirrors, a rear bumper, a back door, and an upper portion of a windshield is the vehicle interior. The imaging unit 12101 mounted in the front nose and the imaging unit 12105 mounted in the upper portion of the windshield in the vehicle interior mainly obtain forward view images of the vehicle 12100. The imaging units 12102 and 12103 mounted in the side mirrors mainly obtain side view images of the vehicle 12100. The imaging unit 12104 mounted in the rear bumper or the back door mainly obtains rear-view images of the vehicle 12100. The forward view images obtained by the imaging units 12101 and 12105 are mainly used to detect a preceding vehicle, a pedestrian, an obstacle, a traffic signal, a traffic sign, a lane, or the like.

Note that FIG. 20 illustrates an example of imaging ranges of the imaging units 12101 to 12104. The imaging range 12111 indicates the imaging range of the imaging unit 12101 provided on the front nose, the imaging ranges 12112 and 12113 indicate the imaging ranges of the imaging units 12102 and 12103 provided on the side mirrors, and the imaging range 12114 indicates the imaging range of the imaging unit 12104 provided on the rear bumper or the back door. It is possible to obtain an overhead image of the vehicle 12100 viewed from above by superimposing data of images captured by the imaging units 12101 to 12104, for example.

At least one of the imaging units 12101 to 12104 may have a function of obtaining distance information. For example, at least one of the imaging units 12101 to 12104 may be a stereo camera including a plurality of imaging devices, or an imaging device having pixels for phase difference detection.

On the basis of the distance information obtained from the imaging units 12101 to 12104, for example, the microcomputer 12051 calculates a distance to each three-dimensional object within the imaging ranges 12111 to 12114 and a temporal change of the distance (relative speed with respect to the vehicle 12100). This allows the microcomputer 12051 to extract a three-dimensional object as a preceding vehicle in particular. The three-dimensional object extracted as the preceding vehicle is an object closest to the vehicle 12100 on a traveling path of the vehicle 12100 and is traveling at a predetermined speed (e.g., 0 km/h or higher) in substantially the same direction as the vehicle 12100. Moreover, the microcomputer 12051 is capable of presetting an inter-vehicle distance to the preceding vehicle that needs to be secured, and performing automatic brake control (including follow-up stop control), automatic acceleration control (including follow-up start control), and the like. In this manner, the microcomputer 12051 is capable of performing cooperative control intended for automatic driving, which makes the vehicle to travel autonomously without depending on the drive's operation, and the like.

For example, the microcomputer 12051 is capable of classifying three-dimensional object data regarding the three-dimensional objects into a two-wheeled vehicle, a regular vehicle, a large vehicle, a pedestrian, and other three-dimensional objects such as utility poles on the basis of the distance information obtained by the imaging units 12101 to 12104, and extracting and using the classified three-dimensional objects to automatically avoid the obstacles. For example, the microcomputer 12051 distinguishes obstacles around the vehicle 12100 as an obstacle that can be visually recognized by the driver of the vehicle 12100 or an obstacle that is difficult for the driver to visually recognize. Then, the microcomputer 12051 determines a collision risk that indicates a risk of collision with each obstacle. In a situation where the collision risk is equal to or higher than a set value and a collision may occur, the microcomputer 12051 is capable of outputting a warning to the driver through the audio speaker 12061 or the display unit 12062 or forcibly reducing the speed or performing avoidance steering through the drive system control unit 12010 to provide driving support for collision avoidance.

At least one of the imaging units 12101 to 12104 may be an infrared camera for detecting infrared light. For example, the microcomputer 12051 is capable of determining whether or not a pedestrian exists in images captured by the imaging units 12101 to 12104 to recognize the pedestrian. Such pedestrian recognition is performed by, for example, a procedure of extracting feature points in the images captured by the imaging units 12101 to 12104 which are infrared cameras and a procedure of performing pattern matching processing on the series of feature points indicating the outline of an object and determining whether or not the object is an pedestrian. In a case where the microcomputer 12051 determines that a pedestrian exists in the images captured by the imaging units 12101 to 12104 and recognizes the pedestrian, the audio/image output unit 12052 controls the display unit 12062 so as to superimpose and display a square outline for emphasis on the recognized pedestrian. Furthermore, the audio/image output unit 12052 may control the display unit 12062 so as to display an icon or the like indicating a pedestrian in a desired position.

The example of the vehicle control system to which the technology according to the present disclosure can be applied has been described above. The technology according to the present disclosure may be applied to the imaging unit 12031 in the configurations described above. Specifically, the optical sensor 13 shown in FIG. 1 can be applied to the imaging unit 12031, for example. By applying the technology according to the present disclosure to the imaging unit 12031, it is possible to prevent a decrease in the accuracy of distance measurement without increasing power consumption, and to contribute to implementation of, for example, the function of ADAS.

Note that the embodiments of the present technology are not limited to the above-described embodiments, and various modifications can be made without departing from the scope of the present technology.

For example, in the fourth configuration example of the pixel array 21 in FIGS. 15 and 16, a color filter 151 can be provided as in the second configuration example of the pixel array 21 in FIGS. 11 and 12.

Furthermore, the effects described herein are not necessarily limitative, and any of the effects described in the present disclosure may be exhibited.

Note that the present technology can be configured as follows.

<1>

An optical sensor including:

a TOF pixel that receives reflected light which is returned when irradiation light emitted from a light emitting unit is reflected on a subject; and

a plurality of polarization pixels that respectively receives light beams of a plurality of polarization planes, the light beams being a part of light from the subject.

<2>

The optical sensor according to <1>,

in which one or more of the TOF pixels and one or more of the polarization pixels are alternately arranged on a plane.

<3>

The optical sensor according to <1>or <2>,

in which the TOF pixel is formed to have a size same as or larger than the polarization pixel.

<4>

The optical sensor according to any one of <1>to <3>,

in which the polarization pixel receives light of a predetermined polarization plane from the subject by receiving light from the subject via a polarizer that passes light of a predetermined polarization plane.

<5>

The optical sensor according to any one of <1>to <4>, further including:

a pass filter formed on the TOF pixel for passing light of a wavelength of the irradiation light; and

a cut filter formed on the polarization pixel for cutting light of the wavelength of the irradiation light.

<6>

The optical sensor according to any one of <1>to <5>,

in which the TOF pixel and the polarization pixel are driven simultaneously or alternately.

<7>

The optical sensor according to any one of <1>to <6>,

in which an absolute distance to the subject calculated using a pixel value of the TOF pixel is corrected using a relative distance to the subject calculated from a normal direction of the subject obtained using pixel values of the plurality of polarization pixels.

<8>

An electronic device including:

an optical system that condenses light; and

an optical sensor that receives light,

the optical sensor including:

a TOF pixel that receives reflected light which is returned when irradiation light emitted from a light emitting unit is reflected on a subject; and

a plurality of polarization pixels that respectively receives light beams of a plurality of polarization planes, the light beams being a part of light from the subject.

### REFERENCE SIGNS LIST

11 Light emitting device
12 Optical system
13 Optical sensor
14 Signal processing device
15 Control device
21 Pixel array
22 Pixel drive unit
23 ADC
31 Pixel
41 Pixel control line
42 VSL
51 PD
52 FET
53 FD
54 to 56 FET
31P Polarization pixel
31T, 31T′ TOF pixel
61 Polarization sensor
62 TOF sensor
71 Band pass filter
72 Cut filter
81 Polarizer
151 Color filter

1. An optical sensor comprising:
a TOF pixel that receives reflected light which is returned when irradiation light emitted from a light emitting unit is reflected on a subject; and
a plurality of polarization pixels that respectively receives light beams of a plurality of polarization planes, the light beams being a part of light from the subject.

2. The optical sensor according to claim 1,
wherein one or more of the TOF pixels and one or more of the polarization pixels are alternately arranged on a plane.

3. The optical sensor according to claim 1,
wherein the TOF pixel is formed to have a size same as or larger than the polarization pixel.

4. The optical sensor according to claim 1,
wherein the polarization pixel receives light of a predetermined polarization plane from the subject by receiving light from the subject via a polarizer that passes light of a predetermined polarization plane.

5. The optical sensor according to claim 1, further comprising:
a pass filter formed on the TOF pixel for passing light of a wavelength of the irradiation light; and
a cut filter formed on the polarization pixel for cutting light of the wavelength of the irradiation light.

6. The optical sensor according to claim 1,
wherein the TOF pixel and the polarization pixel are driven simultaneously or alternately.

7. The optical sensor according to claim 1,
wherein an absolute distance to the subject calculated using a pixel value of the TOF pixel is corrected using a relative distance to the subject calculated from a normal direction of the subject obtained using pixel values of the plurality of polarization pixels.

8. An electronic device comprising:
an optical system that condenses light; and
an optical sensor that receives light,
the optical sensor including:
a TOF pixel that receives reflected light which is returned when irradiation light emitted from a light emitting unit is reflected on a subject; and
a plurality of polarization pixels that respectively receives light beams of a plurality of polarization planes, the light beams being a part of light from the subject.
